(19) United States
(12) Patent Application Publication
(10) Pub. No.: US 2009/0265108 A1
(43) Pub. Date: Oct. 22, 2009

(54) NATURAL WEATHER STATION

(76) Inventors: Raymond CHAN, Hong Kong (CN); Kin Wing Ho, Hong Kong SAR (CN)

Correspondence Address: EAGLE IP LIMITED, 22/F., KWAI HUNG HOLDINGS CENTRE, 89 KING'S ROAD, NORTH POINT, HK

(21) Appl. No.: 12/107,061

(22) Filed: Apr. 21, 2008

(51) Int. Cl. G01W 1/00

(52) U.S. Cl. 702/3

(57) ABSTRACT

A weather station that generates a natural weather phenomenon to represent weather information to a user is disclosed. The weather station comprises a weather information module that obtains weather information, and a weather simulation module that generates a natural weather phenomenon using physical objects. In an embodiment, the weather station generates natural weather phenomenon for rainy, snowy, windy, sunny, cloudy and foggy weathers. Multiple such weather stations can be placed side-by-side to illustrate the weather forecast over a number of days in one locale.

### FIELD OF INVENTION

This invention relates to a device that presents weather information to a user.

### BACKGROUND OF INVENTION

People rely on accurate weather forecasts for a myriad of reasons, such as arranging travel plans, deciding appropriate attire to wear, etc. Weather information presented to a user, however, may not be easily understood. For example, a user may not understand the language in which the information is presented or misinterpret the symbols used to represent the weather condition.

### SUMMARY OF INVENTION

In the light of the foregoing background, it is an object of the present invention to provide an alternate weather station.

Accordingly, the present invention, in one aspect, is a weather station comprising a weather information module that obtains weather information and a weather simulation module connected to the weather information module. The weather simulation module receives the weather information from the weather information module and presents the weather information to a user by generating a natural weather phenomenon in a defined area according to the weather information.

In exemplary embodiments of the present invention, the weather information and weather phenomenon include, but are not limited to, rainfall, sunshine, cloud cover, blowing wind, fog and snow.

In an embodiment of the present invention, the weather station comprises a container with a water reservoir housed therein. A water dispensing mechanism delivers water stored within the water reservoir to a showering mechanism. When the weather information indicates to a rainy day, the water dispensing mechanism activates to simulate rainfall inside the container.

In a variation of the above embodiment, the weather station comprises a container with a pool of foam balls and a foam ball dispensing system connected to the pool of foam balls. When snowy weather is indicated, the foam ball dispensing system activates to simulate snowfall within the container.

In another aspect of the invention, a method for presenting weather information to a user in a defined area is disclosed. The method comprises the steps of obtaining said weather information and generating a natural weather phenomenon within the defined area according to the weather information obtained.

### BRIEF DESCRIPTION OF FIGURES

FIG. 1 is a front elevation view of a weather station according to an exemplary embodiment.

FIG. 2 is a cross sectional view of a weather station according to an exemplary embodiment, indicating rainy weather.

FIG. 3 is an exemplary block diagram of the electronic circuitry in an embodiment.

FIG. 4 is a flow chart of operation of an exemplary embodiment.

FIG. 5 is a cross sectional view of a weather station according to an exemplary embodiment, indicating snowy weather.

FIG. 6 is a cross sectional view of another exemplary embodiment indicating snowy weather.

FIG. 7 is a cross sectional view of a weather station according to an exemplary embodiment, indicating windy weather.

FIG. 8 is a cross sectional view of a weather station according to an exemplary embodiment indicating sunny and cloudy weather.

### DETAILED DESCRIPTION OF THE PREFERRED EMBODIMENTS

As used herein and in the claims, “comprising” means including the following elements but not excluding others.

As used herein and in the claims, “couple” refers to electrical coupling or connection either directly or indirectly via one or more electrical means unless otherwise stated.

As used herein and in the claims, “natural weather phenomenon” refers to a weather phenomenon that occurs in nature. This includes, but is not limited to rain, snow, storm, hurricane, clear or cloudy sky, . . . , etc. “Generating or simulating a natural weather phenomenon” refers to a method of creating a three-dimensional scene that visually represents a natural weather phenomenon for the purpose of conveying the weather information to a user in a natural and intuitive way. Physical objects are used for generation of the natural weather phenomenon. This includes, but not limited to, the use of falling water droplets to represent rain, smoke or mist to represent fog, tiny plastic foam balls to represent snow, different colors of lights and objects appropriately shaped to represent sun and cloud, and air blowing to represent wind.

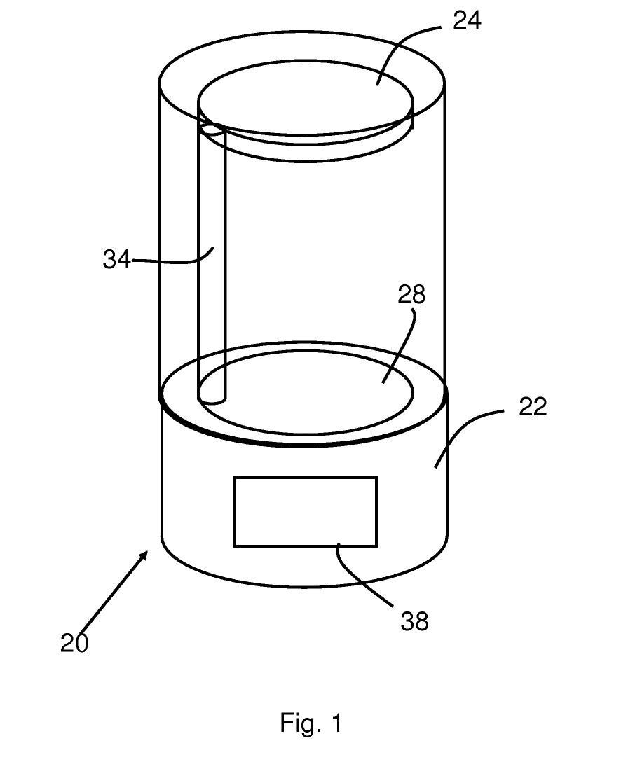

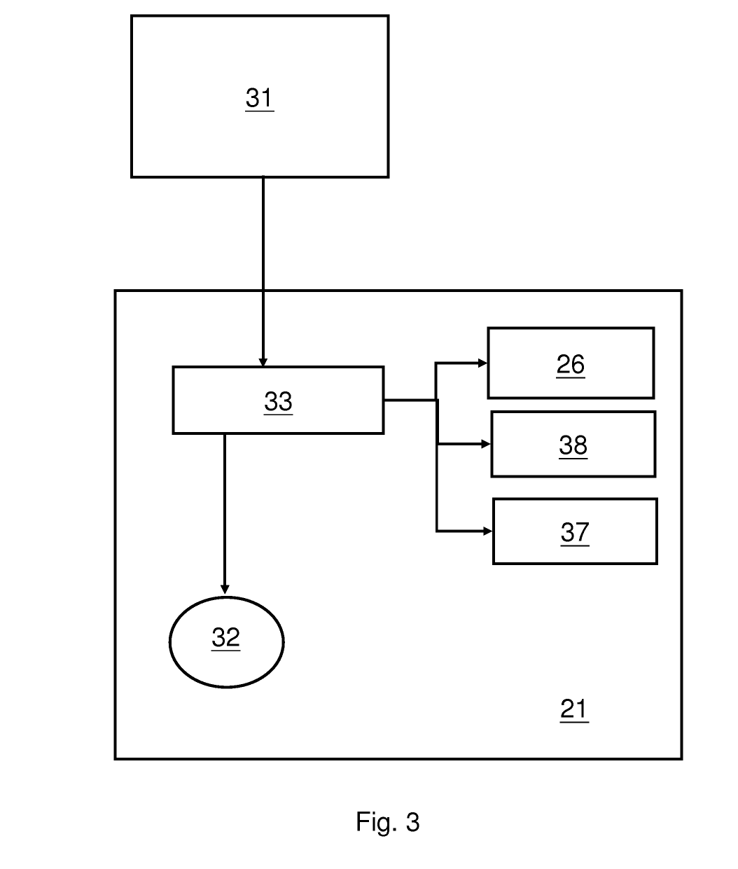

Referring now to FIGS. 1-3, the first embodiment of the present invention is a weather station 20 having a weather simulation module 21 and a weather information module 31. The weather simulation module 21 comprises a container 22, and a water reservoir 28 fillable with water 36 is installed at the bottom of the container 22. A water pipe 34 connected to a water pump 32 has an inlet connected to the water reservoir 28 and an outlet connected to a shower head 24. The shower head 24 is disposed to the top of the container with shower holes facing downwards. A light source 26 is also disposed inside the container. The weather simulation module 21 also comprises a microcontroller 33. The microcontroller 33 and the weather information module 31 are included in electronic circuitry 30 that also controls the water pump 32, the light source 26, an audio output 37 and a display panel 38. In one embodiment, the weather simulation module 21 is interchangeable.

The function of the weather information module 31 is to obtain weather information. There is more than one way to obtain weather information. In one embodiment, the weather information module 31 comprises a plurality of sensors such as barometer or thermometer to obtain weather information of the surrounding environment of the weather station 20 by analyzing atmospheric pressure, temperature, or relative humidity, or other environmental conditions. In another embodiment, the weather information module 31 comprises a wired or wireless transceiver that communicates with an outside source, such as a personal computer, server, or a website, to obtain the weather information. In an exemplary embodiment, the type of weather obtained includes, but is not limited to, rainy, sunny, cloudy, windy, foggy and snowy. It is clear that weather types other than those mentioned above can also be implemented in exemplary embodiments.

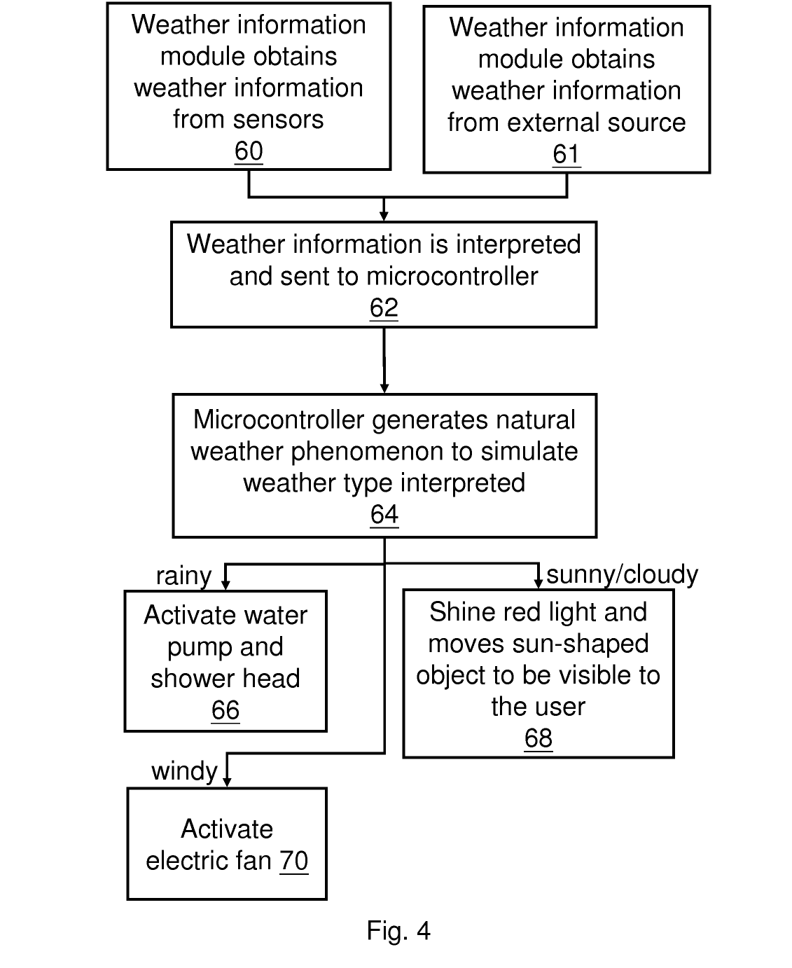

The operation of the weather station 20 is described in a flow chart as shown in FIG. 4. The weather information module 31 first obtains the weather information, either from the sensors (step 60) or an outside source (step 61). The weather information module 31 then interprets the information and sends the weather information to the microcontroller 33 (step 62). According to the weather information, the microcontroller 33 controls different components of the weather simulation module 21 to generate a natural weather phenomenon to simulate the type of weather obtained (step 64). Some examples of the simulation of different weather types (steps 66, 68 and 70) are described below.

When “rainy” is indicated as the weather type, the microcontroller 33 activates the water pump 32 to deliver water 36 from the water reservoir 28 through the water pipe 34 to the shower head 24. The shower head 24 then sprays the water 36 downwards to produce a rainfall effect. The water 36 drops into the water reservoir 28 so that a water flow loop is complete and no water is lost in the loop. In one embodiment, the light source 26 also emits blue light to illuminate the water droplets such that the water 36 appears blue to the user.

In one embodiment, the microcontroller 33 further controls the speed of water pumping and spraying according to the rate of rainfall. If the weather information indicates heavy rain, the pumping and spraying rate is higher, whereas when only a drizzle is indicated, the pumping rate is lower. The rate of rainfall is reflected in this embodiment to provide a more accurate presentation of the weather obtained.

In another embodiment, the water 36 is colored or dyed with a fluorescent pigment that can absorb ambient light energy to create a fluorescent effect under conditions of low ambient light. Using this embodiment, the light source 26 is not needed to illuminate the droplets in low ambient light conditions. This embodiment is more power-efficient and also provides a sharper image to the user in dark surroundings. In one embodiment, the water pump 32 further comprises a water filter that filters water to keep micro-organisms from growing inside the container 22. This increases the operating life of the weather station 20. In an embodiment, the water filter is replaceable by the user.

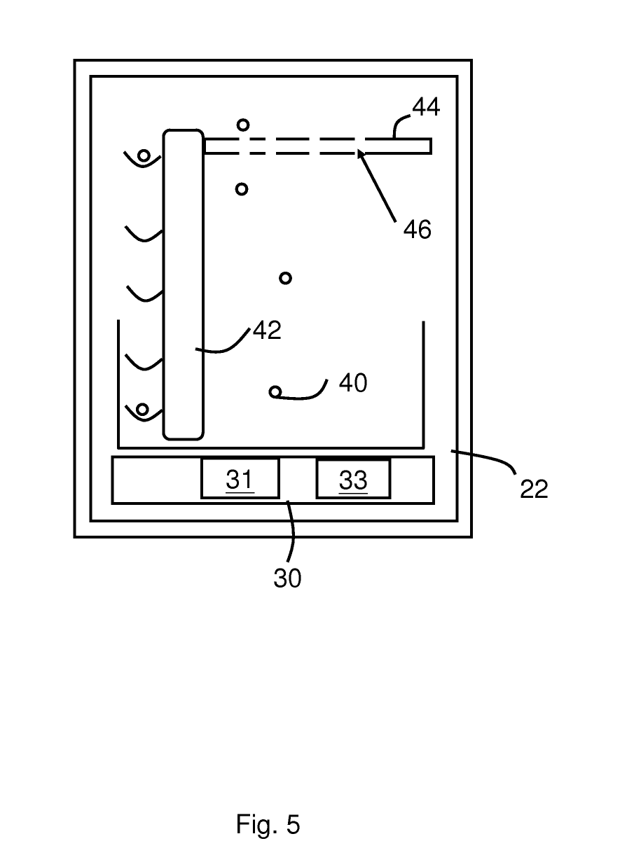

In another exemplary embodiment as shown in FIG. 5, a weather station 20 that generates a natural weather phenomenon indicating snowy weather is illustrated. A pool of tiny plastic foam balls 40 is provided inside the container 22. A foam ball dispensing mechanism is installed inside the container 22. In the dispensing mechanism, a conveyor belt 42 is installed with a bottom end in the pool and a top end at the top of the container 22. A plate 44 provided with a plurality of openings 46 is coupled to the top of the conveyor belt. The size of the opening 46 is designed to allow only a single foam ball 40 to pass through at a time. When snowy weather is indicated, the electronic circuitry 30 activates the conveyor belt 42 to transfer the foam balls 40 upwards onto the top side of the plate 44. The foam balls 40 then fall through the openings 46 and back into the pool. The foam balls 40 have a low density such that the falling speed is slower and are colored or painted white to imitate snow fall.

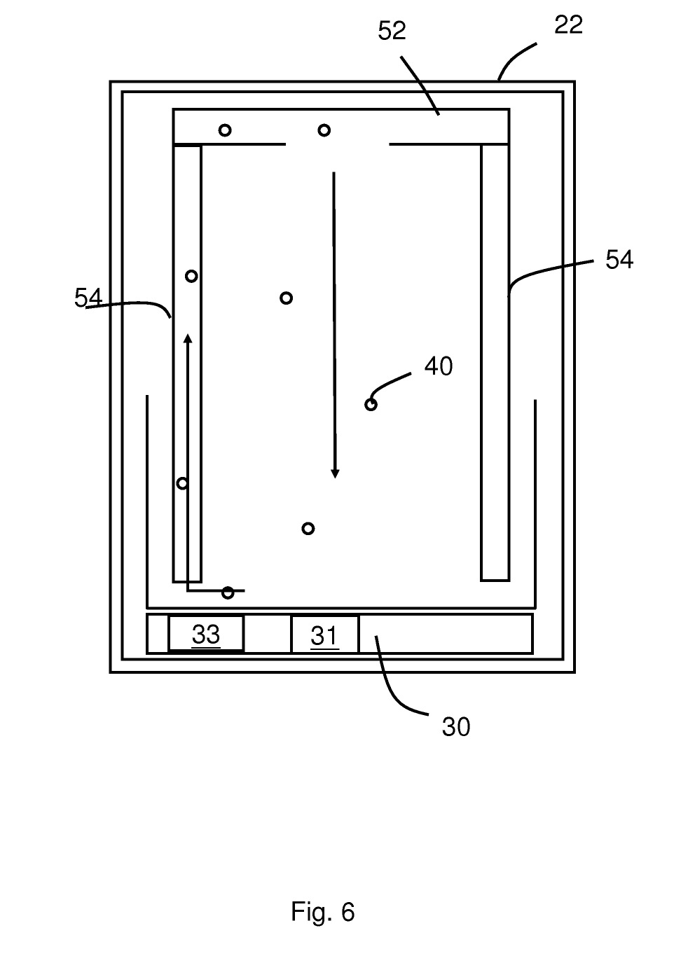

In another exemplary embodiment as shown in FIG. 6, a suction pump 52 is installed at the top of the container 22. When snowy weather is indicated, the microcontroller 33 activates the suction pump 52 to suck the foam balls 40 in the pool to the top of the container 22 through a hollow tube 54. From the top of the container 22, the foam balls 40 drop into the pool to imitate the snowfall phenomenon. The dropped foam balls 40 are ready to be sucked up again to form a loop. It is obvious that any other mechanisms that transfer foam balls 40 to the top can be used in lieu of the foam ball dispensing mechanism as shown in this embodiment.

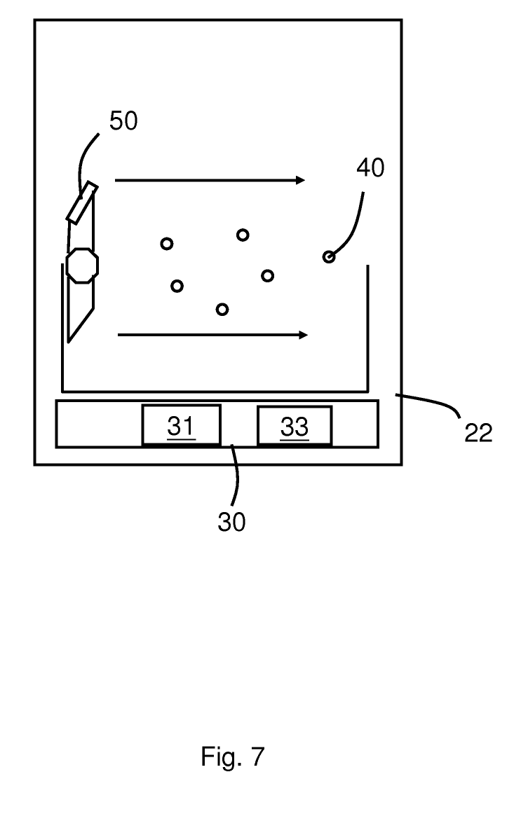

Windy weather can also be simulated using foam balls as illustrated in an embodiment shown in FIG. 7. An air blowing mechanism having a fan 50 is disposed inside the container 22. When windy weather is indicated, the fan 50 activates such that the foam balls 40 move around inside the container 22 as a representation of the windy weather. To disambiguate this with the simulation of snowy weather, the fan 50 is oriented to blow the foam balls 40 in a relatively horizontal direction. It is clear that other objects such as dust can serve the same purpose as the foam balls 40. In another embodiment, soft paper or cloth objects, shaped in the form of a flag or leaves hanging on a tree trunk, can be placed inside the container 22. When the fan 50 blows, the wind it generates causes the paper or cloth objects to wave, showing the natural effect of windy condition. In another embodiment, the speed of the fan can be adjusted according to the weather information received, thus showing gentle breeze against stormy weather conditions. It is clear that suction pumps can also be oriented appropriately to achieve the same effect.

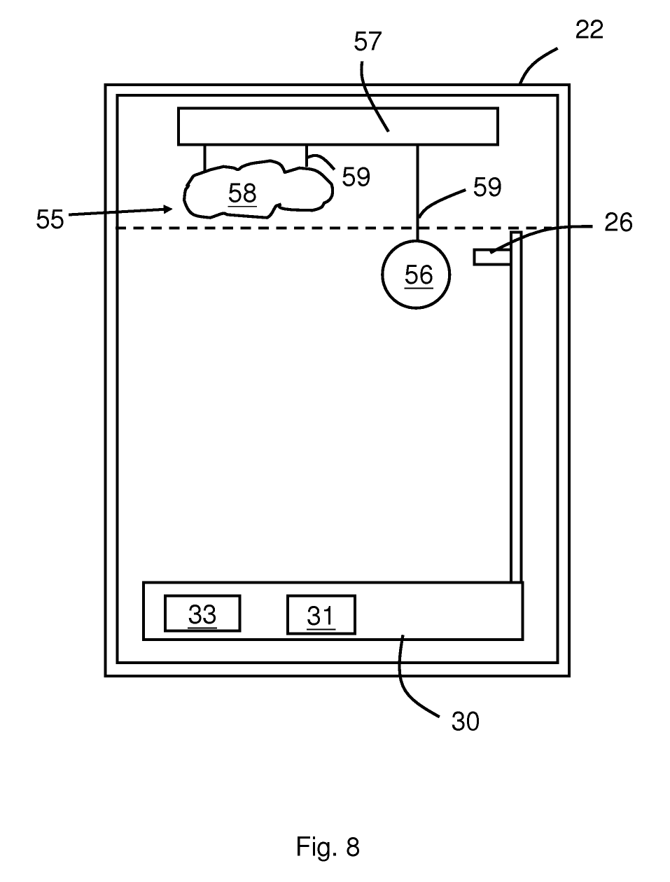

Visual representations of other weather conditions are also possible. In one embodiment, sunny weather is represented by having the light source emitting red light while cloudy weather is represented by blue light. In another embodiment as shown in FIG. 8, a sun-shaped object 56 and a cloud-shaped object 58 are used to represent the weather more clearly to the user. An object displacing mechanism 57 is connected to the objects through a length of wire 59. The sun-shaped object 56 is lowered from a covered area 55 by extending the wire 59 to be visible by the user when sunny weather is indicated. At the same time, the wire 59 connected to the cloud-shaped object 58 retracts so that the cloud-shaped object 58 moves upwards into the covered area 55 to hide from the user, and vice versa. The light source 26 still emits red or blue light according to the weather type. In yet another embodiment, the light source 26 of the corresponding color is housed inside the sun-shaped object 56 and the cloud-shaped object 58 respectively.

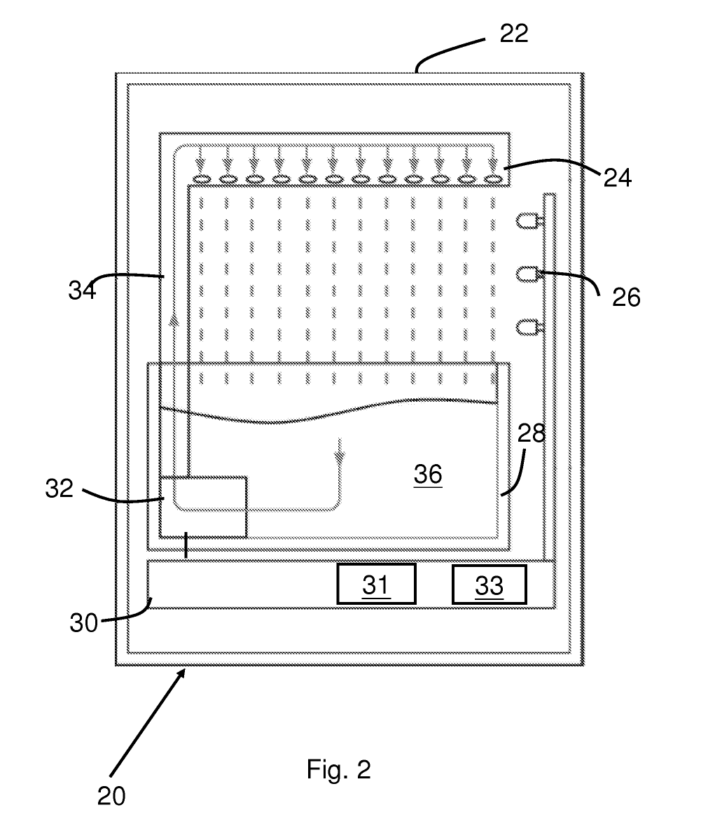

In one embodiment, foggy weather is simulated by generating mist within the container 22. In an exemplary embodiment, the mist is generated from the water 36 in the water reservoir 28 as shown in FIG. 2.

Some of the above ideas can also be combined. In an embodiment, the electric fan 50 is added to the embodiment as shown in FIG. 2. Weather types such as thunderstorm can be represented by activating both the electric fan 50 and the water pump 32, as well as having the light source 26 flash at a certain rate at the same time to simulate wind, rain and lightning respectively. An audio device can also be added to output a thunder sound to provide a more realistic effect.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

It is clear to one skilled in the art that other weather information such as temperature, humidity, or non-weather information such as time can also be displayed to the user through the display panel 38 while the natural weather phenomenon is presented to the user.

In one embodiment, the user has an option to change the time or place that the weather information is to be displayed. In an embodiment, the time or place is selected from the display panel 38.

Multiple containers 22 can be attached together to provide weather information on multiple times or different locales at the same time. For example, the first container displays the weather information today and the second container displays the weather forecast tomorrow, or the first container displays the weather information of the surroundings and the second container displays the weather information of a distant city. In another embodiment, the user can also choose the time and place for each container 22 independently.

The weather station can also combine laser-engraving crystal technology into the unit. An example of the application of the technology is by using a crystal to represent a cloud and different colors of light is shone at the cloud to indicate the different possibilities of raining in the near future.

Other than using physical objects, one embodiment can also use optical techniques such as three-dimensional holography to project a three-dimensional image that represents the weather type to the user.

What is claimed is:

1. A weather station comprising:
a weather information module that obtains weather information;
a weather simulation module that receives the weather information from said weather information module;
wherein said weather simulation module presents said weather information to a user by generating a natural weather phenomenon in a defined area of the weather station.

2. The weather station according to claim 1, wherein said weather information includes weather types of rainy, sunny, cloudy, windy, foggy and snowy.

3. The weather station according to claim 1 wherein said natural weather phenomenon includes rainfall, sunshine, cloud cover, blowing a wind, fog and snow.

4. The weather station according to claim 1, wherein said weather simulation module comprises:
a container
a water reservoir housed within said container;
a showering mechanism; and
a water dispensing system connecting said water reservoir to said showering mechanism and controlled by said weather simulation module, wherein information obtained by said weather information indicating a rainy day results in activation of the water dispensing system to deliver water from the water reservoir to the showering mechanism to simulate rainfall within said container.

5. The weather station according to claim 4, wherein water from said water reservoir is dyed with a fluorescent pigment.

6. The weather station according to claim 4, wherein said water dispensing system is activated at multiple rates according to said weather information.

7. The weather station according to claim 1, wherein said weather simulation module comprises:
a container;
a pool of foam balls housed inside said container;
a foam ball dispensing system connected to said pool of foam balls;
wherein information obtained by said weather information indicating a snowy day results in activation of said foam ball dispensing system to simulate snowfall within said container.

8. The weather station according to claim 7, wherein said foam ball dispensing system comprises:
at least one hollow tube with a bottom end inserted inside said pool of foam balls;
a suction pump to pull said foam balls from said pool to the top of said container through said at least one hollow tube.

9. The weather station according to claim 1, wherein said weather simulation module comprises:
a container;
an opaque object housed inside said container;
an air blowing mechanism;
wherein information obtained by said weather information indicating a windy day results in activation of said air blowing mechanism to generate movement of said opaque object within said container to be perceived by a user.

10. The weather station according to claim 9, wherein said air blowing mechanism is operable at multiple rates.

11. The weather station according to claim 1, wherein said weather simulation module comprises:
a sun-shaped object;
an object displacing mechanism attached to said sun-shaped object through a length of wire;
wherein said object displacing mechanism moves said sun-shaped object to a position that is visible to said user when sunny weather is indicated.

12. The weather station according to claim 11, wherein a light source is housed within said sun-shaped object.

13. The weather station according to claim 1, further comprising an audio source to output an audio message to said user.

14. The weather station according to claim 1, wherein said weather simulation module is interchangeable by said user.

15. The weather station according to claim 1, wherein said weather simulation module generates a natural weather phenomenon according to said weather information at a time and place that said user selects.

16. A weather station comprising:
a weather information module that obtains weather information;
a weather simulation module that receives the weather information from said weather information module;
wherein said weather simulation module uses holographic techniques to display a three-dimensional image emulating the weather information to a user.

17. The weather station according to claim 16, wherein said weather simulation module uses holographic techniques and physical real objects to present said weather information to said user.

18. A method of emulating weather information in a defined area to a user, comprising the steps of:
obtaining said weather information; and
generating a natural weather phenomenon within said defined area according to said weather information obtained.

19. The method according to claim 18, wherein said weather information includes rainy, sunny, cloudy, windy, foggy and snowy.

20. The method according to claim 18, further comprising the step of:
spraying said water downwards from a showering mechanism to emulate rainfall effect when rainy weather is indicated.
